(19) United States
(12) Patent Application Publication
(10) Pub. No.: US 2026/0106073 A1
(43) Pub. Date: Apr. 16, 2026

(54) MOLD FOR PREPARING MAGNETIC BODY HAVING SURFACE MAGNETIC FLUX GATHERING FUNCTION AND MAGNETIC BODY

(71) Applicant: NINGBO JINJI STRONG MAGNETIC MATERIAL CO., LTD, Ningbo (CN)

(72) Inventors: Feng XU, Ningbo (CN); Yong WANG, Ningbo (CN); Cailiang SHI, Ningbo (CN); Yuanhu HU, Ningbo (CN)

(73) Assignee: NINGBO JINJI STRONG MAGNETIC MATERIAL CO., LTD, Ningbo, ZJ (CN)

(21) Appl. No.: 19/294,339

(22) Filed: Aug. 8, 2025

(30) Foreign Application Priority Data
Oct. 16, 2024 (CN) 202411440396.1
Apr. 25, 2025 (CN) 202510526374.5

(51) Int. Cl. H01F 41/02; H01F 7/02

(52) U.S. Cl. CPC H01F 41/0273; H01F 7/02; H01F 41/0266

(57) ABSTRACT

The present disclosure provides a mold for preparing a magnetic body having a surface magnetic flux gathering function. The mold includes a mold cavity, including a cavity opening of the mold cavity and a cavity bottom of the mold cavity; a first alloy block and a second alloy block, the first alloy block and the second alloy block being both movable up and down along an opening direction of the cavity opening of the mold cavity; and two oriented coils, provided in the first alloy block and located in a same horizontal plane, where in a case where currents in opposite directions are fed into the two oriented coils, the two oriented coils respectively form two magnetic fields with magnetic lines distributed in concentric circles.

### BACKGROUND OF THE INVENTION

### 1. Technical Field

The present disclosure belongs to the technical field of preparation of permanent magnet materials, and relates to a mold, in particular to a mold for preparing a magnetic body having a surface magnetic flux gathering function and a magnetic body.

### 2. Description of Related Art

Permanent magnet materials are a kind of important functional material, which are indispensable in modern industry and science and technology. Due to their high magnetic energy densities, the permanent magnet materials quickly become an extremely important basic functional material in the high and new technology industry all over the world. The permanent magnet materials have been widely applied to industries such as computer industry, automobile industry, communication information industry, medical industry, power electronic industry, and smart home industry. Permanent magnets mainly include neodymium iron boron magnets (NdFeB), samarium cobalt permanent magnet alloys (SmCo), aluminum nickel cobalt permanent magnet alloys (AlNiCo), and ferrites. The neodymium iron boron permanent magnet alloys mainly consist of neodymium (Nd), iron (Fe), and boron (B) and have an extremely high magnetic energy product and remanence, which are one of the current commercialized permanent magnet materials with the strongest magnetism. The samarium cobalt permanent magnet alloys mainly consist of samarium (Sm) and cobalt (Co), have a relatively high coercive force and good temperature stability, and can maintain relatively high magnetic performance in a high-temperature environment. The aluminum nickel cobalt permanent magnet alloys mainly consist of aluminum (Al), nickel (Ni), cobalt (Co), and iron (Fe), and have relatively high magnetic performance and temperature stability. The ferrimagnets are a kind of ceramic material consisting of ferric oxides and other metal oxides (for example, oxides of barium (Ba) or strontium (Sr), and have relatively low magnetic energy product and remanence, but are low in cost and good in corrosion resistance. Due to their unique magnetic performance and cost characteristics, different types of permanent magnets are applied to different fields.

With the development of informatization, the demand on performance improvement and convenience and rapidness of electronic information devices on the market is increasingly high. The trends of magnetic lines of currently used permanent magnet materials are arranged in parallel in the forming process, resulting in either the same magnetic force on two sides of a formed magnetic body or the same performance. However, generally in use, performance on one side is only used while performance on the other side cannot be used, resulting in a waste of resources.

### BRIEF SUMMARY OF THE INVENTION

To overcome the above problems in the prior art, an objective of the present disclosure is to provide a mold for preparing a magnetic body with a surface magnetic flux gathering function, which can improve the utilization ratio of the performance of a permanent magnet material and avoid a waste of resources.

The objective of the present disclosure may be achieved by the following technical solution: a mold for preparing a magnetic body with a surface magnetic flux gathering function, including:
a mold cavity, including a cavity opening of the mold cavity and a cavity bottom of the mold cavity, the cavity opening of the mold cavity and the cavity bottom of the mold cavity being oppositely provided up and down;
a first alloy block and a second alloy block, the first alloy block and the second alloy block being both movable up and down along an opening direction of the cavity opening of the mold cavity, where the first alloy block moves to close or open the cavity opening of the mold cavity, and the second alloy block is located at the cavity bottom of the mold cavity and moves to demold a formed magnetic body in the mold cavity; and
two oriented coils, provided in the first alloy block or the second alloy block and located in a same horizontal plane, where in a case where currents in opposite directions are fed into the two oriented coils, the two oriented coils respectively form a first magnetic field and a second magnetic field with magnetic lines distributed in concentric circles, and the magnetic lines generated by the first magnetic field and the second magnetic field repulse each other and do not intersect with each other in a region between the two oriented coils, such that a spacing between any two adjacent magnetic lines on a side of upper and lower sides of the formed magnetic body close to the oriented coils is less than a spacing between corresponding two adjacent magnetic lines on a side away from the oriented coils.

In the mold for preparing a magnetic body having a surface magnetic flux gathering function, in a case where the two oriented coils are provided in the first alloy block and the currents in opposite directions are fed into the oriented coils, a density of the magnetic lines on a side toward the cavity opening of the mold cavity is greater than a density of the magnetic lines on a side toward the cavity bottom of the mold cavity, such that a surface magnetic force on a side close to the cavity opening of the mold cavity is larger than a surface magnetic force on a side away from the cavity bottom of the mold cavity on the formed magnetic body in the mold cavity.

In the mold for preparing a magnetic body having a surface magnetic flux gathering function, the magnetic lines of the magnetic fields formed by the two oriented coils enter the formed magnetic body from the side away from the oriented coils, and leave the formed magnetic body from the side close to the oriented coils and return to corresponding oriented coils.

In the mold for preparing a magnetic body having a surface magnetic flux gathering function, the magnetic lines in the magnetic fields generated by the oriented coils enter from one or more sides of the formed magnetic body in an arc-shaped curve manner, and leave from a side of the formed magnetic body and return to the corresponding oriented coils, and where an included angle between a tangent line entering a side of the formed magnetic body on an arc-shaped curve and a vertical plane is greater than an included angle between a tangent line leaving a side of the formed magnetic body on the corresponding arc-shaped curve and the vertical plane.

In the mold for preparing a magnetic body having a surface magnetic flux gathering function, in a case where the two oriented coils are symmetrically distributed along the mold cavity, a strongest surface magnetic force region on the side toward the oriented coils on the formed magnetic body is located in a middle region of the formed magnetic body; and in a case where the two oriented coils are asymmetrically distributed along the mold cavity, the strongest surface magnetic force region on the side toward the oriented coils on the formed magnetic body is close to a side away from the cavity mold in the two oriented coils.

In the mold for preparing a magnetic body having a surface magnetic flux gathering function, in a case where the two oriented coils are symmetrically distributed along the mold cavity and are located in the first alloy block, outermost magnetic lines of the first magnetic field and the second magnetic field formed by the two oriented coils are tangential to form a point of tangency, and where the point of tangency is located outside the formed magnetic body, and a vertical symmetric axis of the formed magnetic body passes through the point of tangency.

In the mold for preparing a magnetic body having a surface magnetic flux gathering function, the mold cavity further includes a plurality of cavity walls of the mold cavity, located in a lateral part of the mold cavity, where in a case where the two oriented coils are located in the first alloy block along the mold cavity, the magnetic lines of the magnetic fields formed by the two oriented coils enter the formed magnetic body from respective opposite sides of the cavity bottom of the mold cavity and the cavity walls of the mold cavity, and leave the formed magnetic body from an opposite side of the cavity opening of the mold cavity and return to the corresponding oriented coils.

In the mold for preparing a magnetic body having a surface magnetic flux gathering function, a pressing direction of a permanent magnet material in the mold cavity is perpendicular to a demolding direction formed after the permanent magnetic material is pressed and formed.

In the mold for preparing a magnetic body having a surface magnetic flux gathering function, four cavity walls of the mold cavity are provided on the mold cavity, two oppositely provided cavity walls of the mold cavity in the four cavity walls of the mold cavity are movably provided and are movable cavity walls of the mold cavity, and the other two oppositely provided cavity walls of the mold cavity are fixedly provided and are fixed cavity walls of the mold cavity, and where a side where the movable cavity walls of the mold cavity are located is the pressing direction of the permanent magnetic material, and a side where the cavity opening of the mold cavity is located is the demolding direction of the magnetic body after the permanent magnetic material is formed.

In the mold for preparing a magnetic body having a surface magnetic flux gathering function, the pressing direction of the permanent magnetic material in the mold cavity is parallel to an axial direction of each of the oriented coils, and a vertical plane where each of the oriented coils is located is parallel to a vertical plane where the fixed wall cavities of the mold cavity on the corresponding side.

In the mold for preparing a magnetic body having a surface magnetic flux gathering function, the mold further includes a forming template and the mold cavity is located in the forming template, where an included angle α is formed between a connecting line between the lowest point of each of the oriented coils and the highest point of the corresponding side wall on the forming template and a vertical plane where the corresponding side wall is located, and a degree of the included angle α is between 0° and 90°.

In the mold for preparing a magnetic body having a surface magnetic flux gathering function, the degree of the included angle α is between 30° and 70°.

In the mold for preparing a magnetic body having a surface magnetic flux gathering function, the mold further includes:
an operation panel, respectively provided with an upper surface and a lower surface along the demolding direction of the formed magnetic body, the forming template being mounted on the upper surface of the operation panel;
a movable mold mechanism, mounted on the forming template or the upper surface of the operation panel through a first support, an output end of the movable mold mechanism being connected to the first alloy block, where the two oriented coils are provided in parallel in the first alloy block;
a demolding mechanism, mounted on the lower surface of the operation panel through a second support, an output end of the demolding mechanism being connected to the second alloy block, where in a case where the permanent magnetic material is pressed, a surface on a side toward the mold cavity on the second alloy block is flush with the cavity bottom of the mold cavity; and in a case where the magnetic body is formed, the second alloy block stretches into the mold cavity to demold the formed magnetic body; and
a first pressing mechanism and a second pressing mechanism, respectively mounted on the operation panel through a third support and a fourth support and respectively located on two sides of the forming template, where an output end of the first pressing mechanism and an output end of the second pressing mechanism are respectively provided with a first movable part and a second movable part, and the first movable part and the second movable part are respectively two oppositely provided movable cavity walls of the mold cavity on the mold cavity.

In the mold for preparing a magnetic body having a surface magnetic flux gathering function, the first support includes a first support plate parallel to a plane where the cavity opening of the mold cavity is located and each corner of the first support plate is provided with a support column, where one end of the support column is connected to the first support plate and the other end of the support column is connected to forming template or the upper surface of the operation panel, and a power source of the movable mold mechanism is mounted on the first support plate; or the second support is provided in a C shape, and two sides of an opening end of the second support are respectively connected to the lower surface of the operation panel, where a power source of the demolding mechanism is connected to a closed end of the second support; or two slotted holes are provided in the operation panel along the demolding direction of the formed magnetic body, the slotted holes penetrate through the upper surface and the lower surface of the operation panel, and a third support and a fourth support are respectively located in the two slotted holes, where a power source of the first pressing mechanism and a power source of the second pressing mechanism are embedded into the corresponding slotted holes.

The present disclosure further provides a magnetic body using the mold. The magnetic body is one of a neodymium iron boron permanent magnet, a samarium cobalt permanent magnet, an aluminum nickel cobalt permanent magnet, and a ferrimagnet.

In the magnetic body, a method for preparing a magnetic body sequentially includes: smelting, pulverizing, orienting, forming, sintering, and aging; in the orienting process, a fine powder obtained by pulverizing is placed in a mold, then a pulsed power supply is started to open a pulsed magnet field for orientation, magnetic lines of two electric fields enter the magnetic body in an arc shape from a side opposite to the cavity bottom of the mold cavity and a side opposite to the fixed cavity walls of the mold cavity, and leave from a side opposite to the cavity opening of the mold cavity and return to the corresponding oriented coils, where surface magnetic lines on the side same with the cavity opening of the mold cavity on the formed magnetic body are denser.

Compared with the prior art, the present disclosure has the following beneficial effects:
(1) According to the mold for preparing a magnetic body having a surface magnetic flux gathering function provided by the present disclosure, the two oriented coils are located on the same side of the mold cavity and are located in the same horizontal plane; after the currents opposite in direction are fed into the two oriented coils, two magnetic fields that repulse each other are formed, such that the density of the magnetic lines on a side close to the cavity opening of the mold cavity on the formed magnetic body in the mold cavity is inconsistent with that on a side close to the cavity bottom of the mold cavity, where the higher the density, the better the magnetic flux gathering effect and performance. Therefore, the utilization ratio of the performance of the permanent magnet material is improved;
(2) A user may thereby change the position of the strongest surface magnetic force region in a side toward the oriented coil on the formed magnetic body as one or two of the oriented coils move along the horizontal direction, so as to achieve corresponding performance of the needed formed magnetic body, thereby improving the use flexibility of the mold;
(3) The pressing direction of the magnetic body is perpendicular to the demolding direction, and a group of oppositely provided cavity walls of the mold cavity in the four cavity walls of the mold cavity are provided in a movable state, such that during the demolding operation of the formed magnetic body, the formed magnetic body only contacts with two fixed cavity walls of the mold cavity and does not contact with two movable cavity walls of the mold cavity; original four contact surfaces are adjusted to two contact surfaces, such that it is convenient to demold the formed magnetic body, and meanwhile, the probability of deformation of the formed magnetic body in the demolding process is reduced, such that the percent of pass of the products is improved;
(4) By increasing the depth of the mold cavity, a work mode of “one produces more” is achieved, i.e., a formed magnetic body with a larger dimension may be formed by primary forming, and then the formed magnetic body with the larger dimension is cut into a plurality of formed products with needed dimensions by way of cutting. Therefore, the forming efficiency of the magnetic body is improved;
(5) By changing the degree of the included angle α, the radians of the magnetic lines are achieved when the magnetic lines of the magnetic fields generated by the oriented coils enter the formed magnetic body; when the degree of the included angle α is too great, the radians of the magnetic lines are great synchronously, such that the formed magnetic body is easily cracked in processes from sintering to compacting; and when the degree of the included angle α is too less, the radians of the magnetic lines are too gentle, such that the performance of the products is improved to a small extent, and anisotropic products cannot be formed. Therefore, the degree of the included angle α is preferably between 30° and 70°.

### BRIEF DESCRIPTION OF THE SEVERAL VIEWS OF THE DRAWINGS

FIG. 1 is a schematic diagram of magnetic fields formed after currents are fed into two oriented coils according to the present disclosure.

FIG. 2 is a schematic structural diagram of a mold for preparing a magnetic body having a surface magnetic flux gathering function according to the present disclosure.

FIG. 3 is a partial schematic structural diagram of a mold for preparing a magnetic body having a surface magnetic flux gathering function according to the present disclosure.

FIG. 4 is a partial sectional view of a mold for preparing a magnetic body having a surface magnetic flux gathering function according to the present disclosure.

FIG. 5 is a schematic structural diagram of a forming template in a preferred embodiment of the present disclosure.

FIG. 6 is a schematic structural diagram of an operation panel in a preferred embodiment of the present disclosure.

FIG. 7 is a schematic structural diagram of a guide structure in a preferred embodiment of the present disclosure.

FIG. 8 is a distribution diagram of magnetic lines passing through a magnetic body in an orientation process in an implementation of the present disclosure.

FIG. 9 is a schematic diagram of a shape of a magnetic body in an implementation of the present disclosure.

FIG. 10 is a curve graph of distributions of surface magnetic flux densities of upper and lower surfaces of the magnetic body prepared in Embodiment 1, where (a) is a curve graph of distribution of the surface magnetic flux density of the upper surface, and (b) is a curve graph of distribution of the surface magnetic flux density of the lower surface.

FIG. 11 is a curve graph of distributions of surface magnetic flux densities of upper and lower surfaces of the magnetic body prepared in Embodiment 2, where (a) is a curve graph of distribution of the surface magnetic flux density of the upper surface, and (b) is a curve graph of distribution of the surface magnetic flux density of the lower surface.

FIG. 12 is a curve graph of distributions of surface magnetic flux densities of upper and lower surfaces of the magnetic body prepared in Embodiment 3, where (a) is a curve graph of distribution of the surface magnetic flux density of the upper surface, and (b) is a curve graph of distribution of the surface magnetic flux density of the lower surface.

FIG. 13 is a curve graph of distributions of surface magnetic flux densities of upper and lower surfaces of the magnetic body prepared in Embodiment 4, where (a) is a curve graph of distribution of the surface magnetic flux density of the upper surface, and (b) is a curve graph of distribution of the surface magnetic flux density of the lower surface.

FIG. 14 is a curve graph of distributions of surface magnetic flux densities of upper and lower surfaces of the magnetic body prepared in Embodiment 5, where (a) is a curve graph of distribution of the surface magnetic flux density of the upper surface, and (b) is a curve graph of distribution of the surface magnetic flux density of the lower surface.

FIG. 15 is a curve graph of distributions of surface magnetic flux densities of upper and lower surfaces of the magnetic body prepared in Embodiment 6, where (a) is a curve graph of distribution of the surface magnetic flux density of the upper surface, and (b) is a curve graph of distribution of the surface magnetic flux density of the lower surface.

In the drawings,
100, forming template; 110, mold cavity; 111, cavity opening of mold cavity; 112, cavity bottom of mold cavity; 113, cavity wall of mold cavity;
200, operation panel; 210, upper surface; 220, lower surface; 230, slotted hole; 240, third support; 250, fourth support;
300, movable mold mechanism; 310, first support; 311, first support plate; 312, support column; 313, fixed plate; 314, sleeve; 315, guide bar; 320, first alloy block; 330, oriented coil;
400, demolding mechanism; 410, second support; 420, second alloy block;
500, first pressing mechanism; 510, first movable part;
600, second pressing mechanism; 610, second movable part;
700, box body.

### DETAILED DESCRIPTION OF THE INVENTION

The following are specific embodiments of the present disclosure, and the technical solutions of the present disclosure are further described in conjunction with drawings. However, the present disclosure is not limited to the following embodiments.

It should be noted that all directional indications (for example, upper, lower, left, right, front, back, and the like) in the embodiments of the present disclosure are merely used for explaining relative position relations, moving conditions, and the like among components in a certain special gesture (as shown in the drawings). If the special gesture changes, the directional indications change correspondingly.

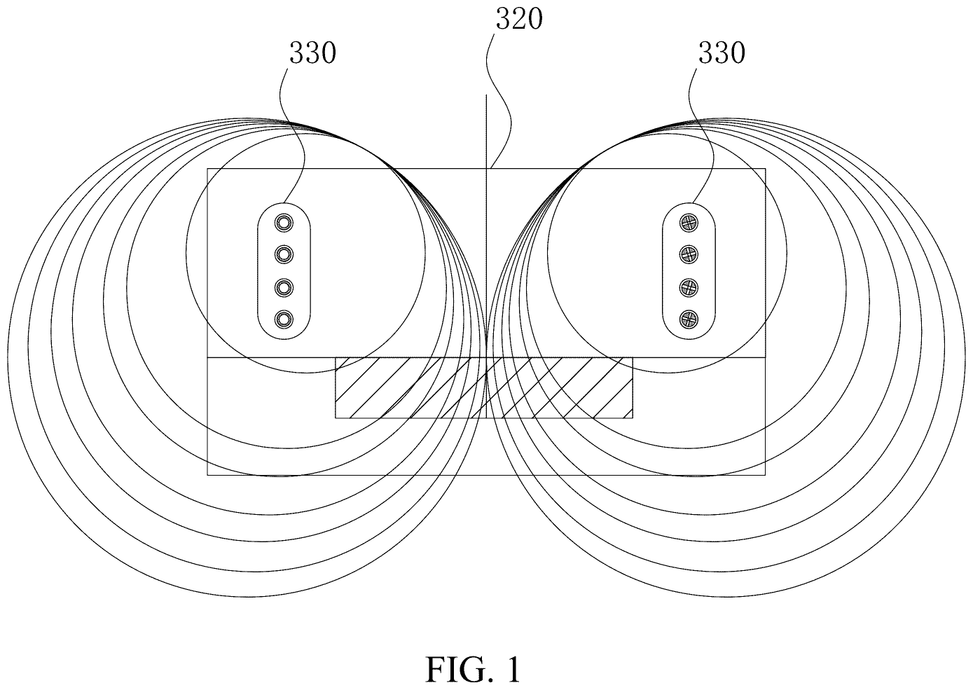

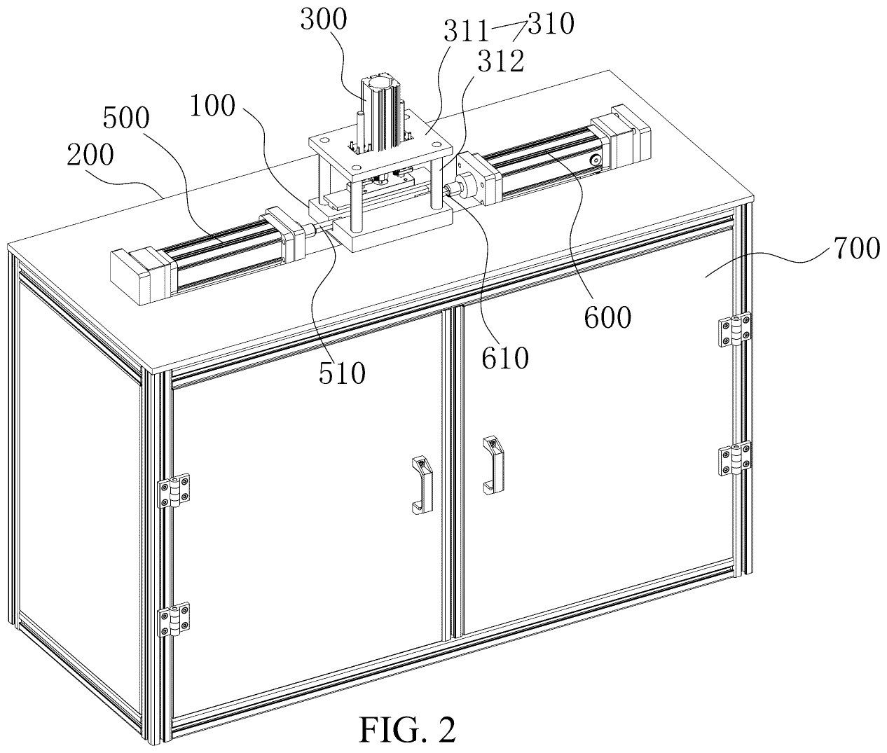

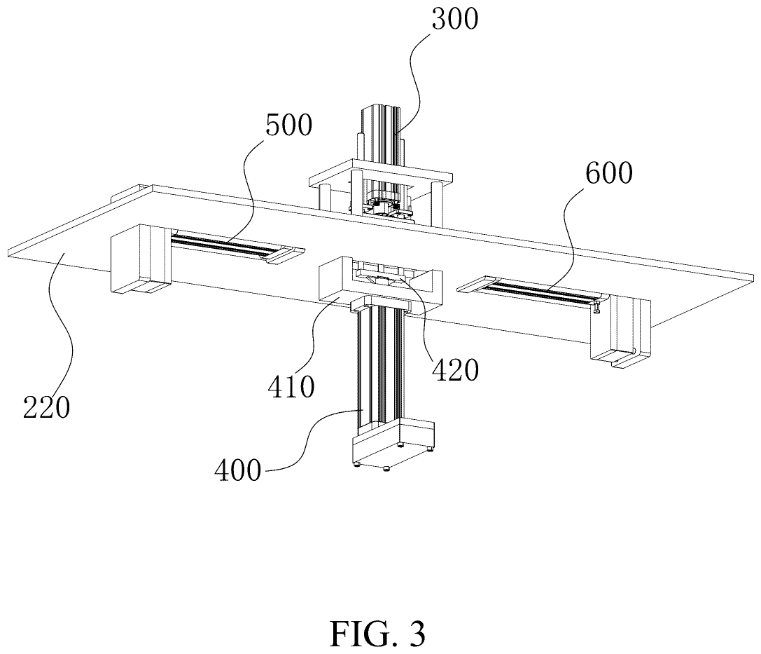

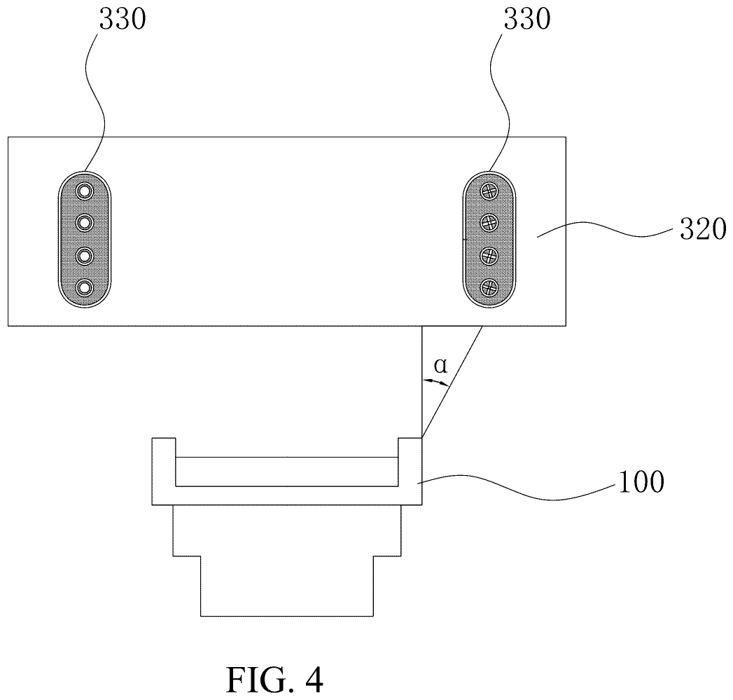

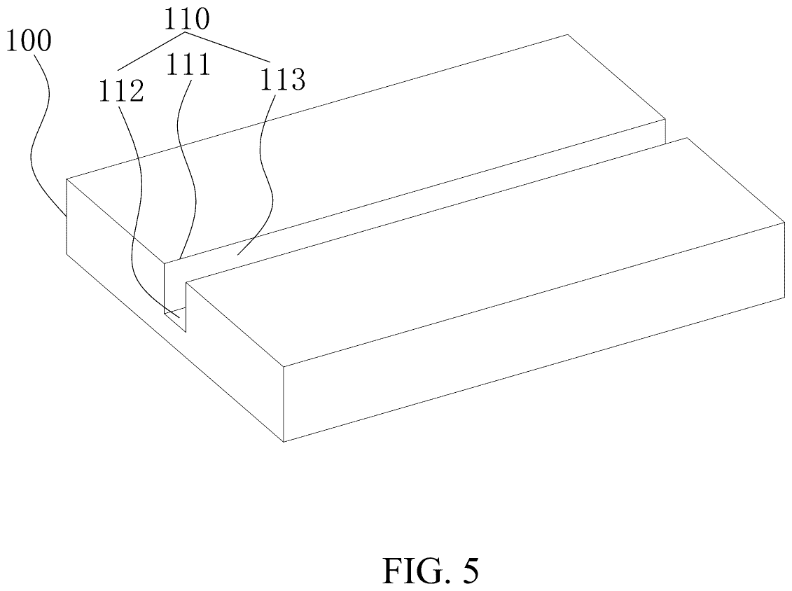

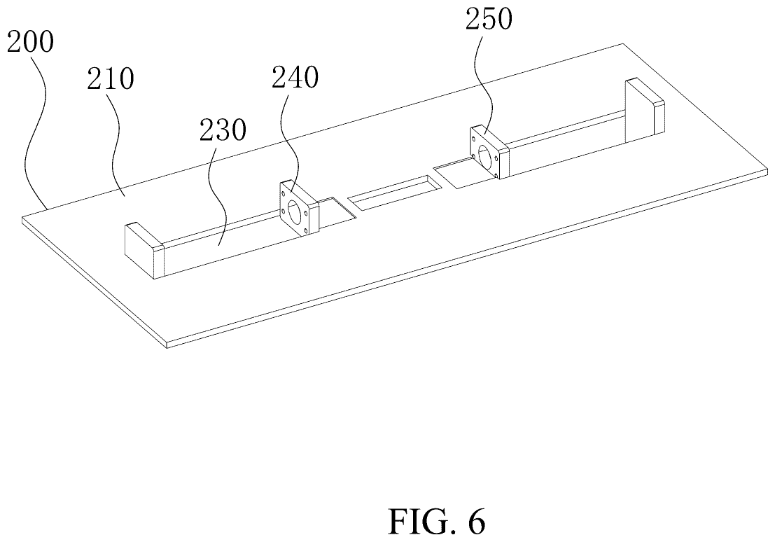

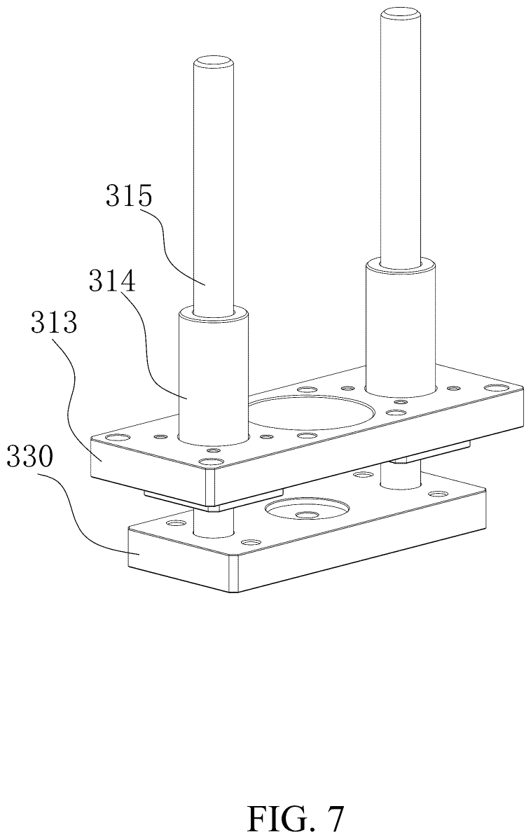

As shown in FIGS. 1-7, a mold for preparing a magnetic body having a surface magnetic flux gathering function provided by the present disclosure includes:
a mold cavity 110, which is a sunken cavity, including a cavity opening 111 of the mold cavity and a cavity bottom 112 of the mold cavity, the cavity opening 111 of the mold cavity and the cavity bottom 112 of the mold cavity being oppositely provided up and down;
a first alloy block 320 and a second alloy block 420, the first alloy block 320 and the second alloy block 420 being both movable up and down along an opening direction of the cavity opening 111 of the mold cavity, where the first alloy block 320 moves to close or open the cavity opening 111 of the mold cavity, and the second alloy block 420 is located at the cavity bottom 112 of the mold cavity and moves to demold a formed magnetic body in the mold cavity 110; and
two oriented coils 330, provided in the first alloy block 320 or the second alloy block 420 and located in a same horizontal plane, where in a case where currents in opposite directions are fed into the two oriented coils 330, the two oriented coils 330 respectively form a first magnetic field and a second magnetic field with magnetic lines distributed in concentric circles, and the magnetic lines generated by the first magnetic field and the second magnetic field repulse each other and do not intersect with each other in a region between the two oriented coils 330, such that a spacing between any two adjacent magnetic lines on a side of upper and lower sides of the formed magnetic body close to the oriented coils 330 is less than a spacing between corresponding two adjacent magnetic lines on a side away from the oriented coils 330.

It is worth noting that in a case where the two oriented coils 330 are provided in the first alloy block 320 and currents in opposite directions are fed, the spacing between any two adjacent magnetic lines on a side toward the cavity opening 111 of the mold cavity is less than the spacing between corresponding two adjacent magnetic lines on a side toward the cavity bottom 112 of the mold cavity, i.e., the density of the magnetic lines on a side toward the cavity opening 111 of the mold cavity is less than the density of the magnetic lines on a side toward the cavity bottom 112 of the mold cavity, such that the surface magnetic force on a side close to the cavity opening 111 of the mold cavity is larger than the surface magnetic force on a side away from the cavity bottom 112 of the mold cavity on the formed magnetic body in the mold cavity 110; in a case where the two oriented coils 330 are provided in the second alloy block 420 and currents in opposite directions are fed, the spacing between any two adjacent magnetic lines on a side toward the cavity opening 111 of the mold cavity is less than the spacing between corresponding two adjacent magnetic lines on a side toward the cavity bottom 112 of the mold cavity, i.e., the density of the magnetic lines on a side toward the cavity bottom 112 of the mold cavity is greater than the density of the magnetic lines on a side toward the cavity opening 111 of the mold cavity, such that the surface magnetic force on a side close to the cavity opening 111 of the mold cavity is smaller than the surface magnetic force on a side away from the cavity bottom 112 of the mold cavity on the formed magnetic body in the mold cavity 110.

It is worth noting that the surface magnetic force in the magnetic body refers to the magnetic field intensity or magnetic flux density measured on the surface of the magnetic body, which describes the intensity of the magnetic field at a certain point on the surface of the magnetic body.

According to the mold for preparing a magnetic body having a surface magnetic flux gathering function provided by the present disclosure, the two oriented coils 330 are located on the same side of the mold cavity and are located in the same horizontal plane; after the currents opposite in direction are fed into the two oriented coils 330, two magnetic fields that repulse each other are formed, such that the density of the magnetic lines on a side close to the cavity opening 111 of the mold cavity on the formed magnetic body in the mold cavity 110 is inconsistent with that on a side close to the cavity bottom 112 of the mold cavity, where the higher the density, the better the magnetic flux gathering effect and performance. Therefore, the utilization ratio of the performance of the permanent magnet material is improved.

It is further noted that the magnetic lines in the magnetic fields generated by the oriented coils 330 enter from one or more sides of the formed magnetic body in an arc-shaped curve manner, and leave from a side of the formed magnetic body and return to the corresponding oriented coils 330, where the radian of one side of the arc-shaped curve entering the formed magnetic body is less than the radian of one side of the arc-shaped curve leaving the formed magnetic body. That is, the arc of one side of the arc-shaped curve entering the formed magnetic body is relatively gentle, and the arc of one side of the arc-shaped curve leaving the formed magnetic body is steep.

It is worth noting that the included angle between a tangent line entering a side of the formed magnetic body on an arc-shaped curve and a vertical plane is greater than the included angle between a tangent line leaving a side of the formed magnetic body on the corresponding arc-shaped curve and the vertical plane.

It is further noted that the magnetic lines of the magnetic fields formed by the two oriented coils 330 enter the formed magnetic body from the side away from the oriented coils 330, and leave the formed magnetic body from the side close to the oriented coils 330 and return to corresponding oriented coils 330.

It is worth noting that the mold cavity 110 further includes a plurality of cavity walls 113 of the mold cavity, located in a lateral part of the mold cavity 110, where in a case where the two oriented coils 330 are symmetrically distributed along the mold cavity 110 and are located in the first alloy block 320, the magnetic lines of the magnetic fields formed by the two oriented coils 330 enter the formed magnetic body from respective opposite sides of the cavity bottom 112 of the mold cavity and the cavity walls 113 of the mold cavity, and leave the formed magnetic body from an opposite side of the cavity opening 111 of the mold cavity and return to the corresponding oriented coils 330; and in a case where the two oriented coils 330 are symmetrically distributed along the mold cavity 110 and are located in the second alloy block 420, the magnetic lines of the magnetic fields formed by the two oriented coils 330 enter the formed magnetic body from respective opposite sides of the cavity opening 111 of the mold cavity and the cavity walls 113 of the mold cavity, and leave the formed magnetic body from an opposite side of the cavity bottom 112 of the mold cavity and return to the corresponding oriented coils 330.

It is further noted that in a case where the two oriented coils 330 are symmetrically distributed along the mold cavity 110 and are located in the first alloy block 320, outermost magnetic lines of the first magnetic field and the second magnetic field formed by the two oriented coils 330 are tangential to form a point of tangency, where the point of tangency is located outside the formed magnetic body, and a vertical symmetric axis of the formed magnetic body passes through the point of tangency.

It is further noted that in a case where one or two of the two oriented coils 330 move along the horizontal direction and the distances between the two oriented coils 330 and the mold cavity 110 in the horizontal direction are not equal, the strongest surface magnetic force region on the side toward the oriented coils 330 on the formed magnetic body will deviate.

It is worth noting that in a case where the two oriented coils 330 are symmetrically distributed along the mold cavity 110, the strongest surface magnetic force region on the side toward the oriented coils 330 on the formed magnetic body is located in a middle region of the formed magnetic body; and in a case where the two oriented coils 330 are asymmetrically distributed along the mold cavity 110, the strongest surface magnetic force region on the side toward the oriented coils 330 on the formed magnetic body is close to a side away from the cavity mold 110 in the two oriented coils 330.

In this embodiment, the user may change the position of the strongest surface magnetic force region in a side toward the oriented coils 330 on the formed magnetic body as one or two of the oriented coils 330 move along the horizontal direction, so as to achieve corresponding performance of the needed formed magnetic body, thereby improving the use flexibility of the mold.

Preferably, a pressing direction of a permanent magnet material in the mold cavity 110 is perpendicular to a demolding direction formed after the permanent magnetic material is pressed and formed.

It is further noted that four cavity walls 113 of the mold cavity are provided on the mold cavity 110, two oppositely provided cavity walls 113 of the mold cavity in the four cavity walls 113 of the mold cavity are movably provided and are movable cavity walls of the mold cavity, and the other two oppositely provided cavity walls 113 of the mold cavity are fixedly provided and are fixed cavity walls of the mold cavity, where a side where the movable cavity walls of the mold cavity are located is the pressing direction of the permanent magnetic material, and a side where the cavity opening 111 of the mold cavity is located is the demolding direction of the magnetic body after the permanent magnetic material is formed.

It is worth noting that in the prior art, the pressing direction of the formed magnetic body is consistent with the demolding direction, and the four cavity walls 113 of the mold cavity 110 are all fixed cavity walls of the mold cavity, such that each side edge of the magnetic body contacts with the corresponding fixed cavity wall of the mold cavity during demolding, i.e., four contact surfaces are provided between the formed magnetic body and the fixed cavity walls of the mold cavity. On the one hand, the demolding difficulty of the formed magnetic body is increased, and on the other hand, due to more contact surfaces, the formed magnetic body is thin, such that the formed magnetic body easily deforms during demolding, and the final percent of pass of the products is decreased.

In this embodiment, the pressing direction of the magnetic body is perpendicular to the demolding direction, and a group of oppositely provided cavity walls 113 of the mold cavity in the four cavity walls 113 of the mold cavity are provided in a movable state, such that during the demolding operation of the formed magnetic body, the formed magnetic body only contacts with two fixed cavity walls of the mold cavity and does not contact with two movable cavity walls of the mold cavity; original four contact surfaces are adjusted to two contact surfaces, such that it is convenient to demold the formed magnetic body, and meanwhile, the probability of deformation of the formed magnetic body in the demolding process is reduced, such that the percent of pass of the products is improved;

It is further noted that in the prior art, the pressing direction of the formed magnetic body is consistent with the demolding direction, such that, in order to control the deformation quantity of the formed magnetic body during demolding, a work mode of “one produces one” is generally used, i.e., one formed magnetic body is only formed by primary forming. In this embodiment, since the pressing direction of the formed magnetic body is perpendicular to the demolding direction, by increasing the depth of the mold cavity 110, a work mode of “one produces more” is achieved, i.e., a formed magnetic body with a larger dimension may be formed by primary forming, and then the formed magnetic body with the larger dimension is cut into a plurality of formed products with needed dimensions by way of cutting. Therefore, the forming efficiency of the magnetic body is improved.

Further preferably, the pressing direction of the permanent magnetic material in the mold cavity 110 is parallel to an axial direction of each of the oriented coils 330, and a vertical plane where each of the oriented coils 330 is located is parallel to a vertical plane where the fixed wall cavities of the mold cavity on the corresponding side.

Preferably, the mold further includes a forming template 100 and the mold cavity 110 is located in the forming template 100, where an included angle α is formed between a connecting line between the lowest point of each of the oriented coils 330 and the highest point of the corresponding side wall on the forming template 100 and a vertical plane where the corresponding side wall is located, and a degree of the included angle α is between 0° and 90°.

It is further noted that in a case where the two oriented coils 330 are close to each other, the degree of the included angle α is decreased; in a case where the two oriented coils 330 are away from each other, the degree of the included angle α is increased; a case where the two oriented coils 330 are close to each other and the vertical plane where the axis of each of the oriented coils 330 is coplanar with the vertical plane where the corresponding side wall on the forming template 100, the degree of the included angle α is 0°; and in a case where the two oriented coils 330 are away from each other enough, the degree of the included angle α is infinitely close to 90°.

In this embodiment, by changing the degree of the included angle α, the radians of the magnetic lines are achieved when the magnetic lines of the magnetic fields generated by the oriented coils 330 enter the formed magnetic body; when the degree of the included angle α is too great, the radians of the magnetic lines are great synchronously, such that the formed magnetic body is easily cracked in processes from sintering to compacting; and when the degree of the included angle α is too less, the radians of the magnetic lines are too gentle, such that the performance of the products is improved to a small extent, and anisotropic products cannot be formed.

It is further noted that the degree of the included angle α is preferably between 30° and 70°.

Preferably, the mold further includes:
an operation panel 200, respectively provided with an upper surface 210 and a lower surface 220 along the demolding direction of the formed magnetic body, the forming template 100 being mounted on the upper surface 210 of the operation panel 200;
a movable mold mechanism 300, mounted on the forming template 100 or the upper surface 210 of the operation panel 200 through a first support 310, an output end of the movable mold mechanism 300 being connected to the first alloy block 320, where the two oriented coils 330 are provided in parallel in the first alloy block 320;
a demolding mechanism 400, mounted on the lower surface 220 of the operation panel 200 through a second support 410, an output end of the demolding mechanism 400 being connected to the second alloy block 420, where in a case where the permanent magnetic material is pressed, a surface on a side toward the mold cavity 110 on the second alloy block 420 is flush with the cavity bottom 112 of the mold cavity; and in a case where the magnetic body is formed, the second alloy block 420 stretches into the mold cavity 110 to demold the formed magnetic body; and
a first pressing mechanism 500 and a second pressing mechanism 600, respectively mounted on the operation panel 200 through a third support 240 and a fourth support 250 and respectively located on two sides of the forming template 100, where an output end of the first pressing mechanism 500 and an output end of the second pressing mechanism 600 are respectively provided with a first movable part 510 and a second movable part 610, and the first movable part 510 and the second movable part 610 are respectively two oppositely provided movable cavity walls of the mold cavity on the mold cavity 100.

It is worth noting that a forming principle of the formed magnetic body is as follows: in an initial state, the first movable part 510 and the second movable part 610 of the first pressing mechanism 500 and the second pressing mechanism 600 are respectively used as the movable cavity walls of the mold cavity to block the left and right sides of the mold cavity 110. A side toward the mold cavity 110 on the second alloy block 420 at the output end of the demolding mechanism 400 is flush with the plane where the cavity bottom 112 of the mold cavity is located, such that the bottom and sides of the entire mold cavity 110 are in a closed state. In this case, the permanent magnet material fills the mold cavity 110 and the entire mold cavity 110 is fully filled with the permanent magnet material; then, the movable mold mechanism 300 drives the first alloy block 320 to move along a direction close to the mold cavity 110 and close the cavity opening 111 of the mold cavity; then a pulsed power supply is started to open a pulsed magnet field for orientation, the number of pulsed orientation is 3-6, and the pulsed magnet field is not less than 1T, such that there is a difference between the surface magnetic force on a side toward the cavity opening 111 of the mold cavity and the surface magnetic force on a side toward the cavity bottom 112 of the mold cavity on the permanent magnet material in the mold cavity 110, i.e., the surface magnetic force on a side toward the cavity opening 111 of the mold cavity on the permanent magnet material is larger than the surface magnetic force on a side toward the cavity bottom 112 of the mold cavity; then the first pressing mechanism 500 and the second pressing mechanism 600 respectively drive the first movable part 510 and the second movable part 610 to move in opposition directions to press the permanent magnet material, so as to form the magnetic body, where the density of the pressed and formed magnetic body is controlled at 3.8-4.5 g/cm³, and the pressure is not less than 5 tons, preferably 8-15 tons (due to too small size of the product, the formed magnetic body is easily crushed due to too large pressure); and finally, after the magnetic body is pressed, the first pressing mechanism 500 and the second pressing mechanism 600 respectively drive the first movable part 510 and the second movable part 610 again to move along a direction away from the mold cavity 110 to open the movable cavity walls of the mold cavity 110, and the demolding mechanism 400 drives the second alloy block 420 to move toward the direction of the cavity opening 111 of the mold cavity to demold the formed magnetic body.

Further, it is worth noting that a power source of the movable mold mechanism 300, the demolding mechanism 400, the first pressing mechanism 500, and the second pressing mechanism 600 may be an air cylinder or an oil cylinder or a linear electric machine, but is not limited to the air cylinder or the oil cylinder or the linear electric machine.

Preferably, the first support 310 includes a first support plate 311 parallel to a plane where the cavity opening 111 of the mold cavity is located and each corner of the first support plate 311 is provided with a support column 312, where one end of the support column 312 is connected to the first support plate 311 and the other end of the support column 312 is connected to forming template 100 or the upper surface 210 of the operation panel 200, and a power source of the movable mold mechanism 300 is mounted on the first support plate 311.

Further preferably, a guide structure is further provided between the power source of the movable mold mechanism 300 and the first alloy block 320, and the guide structure includes a fixed plate 313 clamped between the first support plate 311 and the power source of the movable mold mechanism 300, where the fixed plate 313 is provided with a sleeve 314, and a guide bar 315 connected to the first alloy block 320 is embedded into the sleeve 314.

Preferably, the second support 410 is provided in a C shape, and two sides of an opening end of the second support 410 are respectively connected to the lower surface 220 of the operation panel 200, where a power source of the demolding mechanism 400 is connected to a closed end of the second support 410.

Preferably, two slotted holes 230 are provided in the operation panel 200 along the demolding direction of the formed magnetic body, the slotted holes 230 penetrate through the upper surface 210 and the lower surface 220 of the operation panel 200, and a third support 240 and a fourth support 250 are respectively located in the two slotted holes 230, where a power source of the first pressing mechanism 500 and a power source of the second pressing mechanism 600 are embedded into the corresponding slotted holes 230.

Preferably, the mold further includes a box body 700, and the operation panel 200 is mounted on the box body 700, where the forming template 100 and the movable mold mechanism 300 are located outside the box body 700, the demolding mechanism 400 is located in the box body 700, a part of structures of the first pressing mechanism 500 and the second pressing mechanism 600 is located outside the box body 700, and the other part of structures thereof is located in the box body 700.

The present disclosure further provides a magnetic body. The magnetic body may be a neodymium iron boron permanent magnet, a samarium cobalt permanent magnet, an aluminum nickel cobalt permanent magnet, or a ferrimagnet.

It is further noted that the neodymium iron boron permanent magnet is a permanent magnet material prepared from an alloy based on neodymium, iron, and boron, and the alloy designation includes N series (for example, N30, N33, N35, N38, N40, N42, N45, N48, N50, N52, and the like), M series (for example, M28, M35, M38, M45, M50, M55, M60, M70, M80, and the like), H series (for example, 35H, 38H, 45H, 48H, and the like), SH series (42SH), UH series (35UH, and the like), EH series, and the like.

The samarium cobalt permanent magnet is a permanent magnet material prepared from an alloy based on samarium and cobalt, and mainly includes 1:5 type and 2:17 type.

The aluminum nickel cobalt permanent magnet mainly consists of aluminum, nickel, cobalt, and iron, and additionally includes other alloy elements which may be listed as follows: copper, titanium, zirconium, silicon, manganese, and the like. The alloy designation includes AlNiCo1, AlNiCo2, AlNiCo3, AlNiCo4, AlNiCo5, AlNiCo6, AlNiCo7, AlNiCo8, AlNiCo9, and the like.

The ferrimagnet is a composite material based on ferric oxide and other metal oxides. Other metal oxides may be listed as follows: barium oxide, strontium oxide, cobalt oxide, manganese oxide, nickel oxide, zinc oxide, magnesium oxide, and the like. The alloy designation mainly includes Y10T, Y20, Y25, Y30, Y30BH, Y33, Y35, and the like.

The present disclosure further provides a method for preparing a magnetic body, sequentially including: smelting, pulverizing, orienting, forming, sintering, and aging; during orientation, a fine powder obtained by pulverizing is first placed in a mold, then a pulsed power supply is started to open a pulsed magnet field for orientation, where the number of pulsed orientation is 3-6 times, the pulsed magnetic field is not less than 1T, the magnetic lines of two electric fields enter the magnetic body in an arc shape from a side opposite to the cavity bottom 112 of the mold cavity and a side opposite to the fixed cavity walls of the mold cavity, and leave from a side opposite to the cavity opening 111 of the mold cavity and return to the corresponding oriented coils 330, where surface magnetic lines on the side same with the cavity opening 111 of the mold cavity on the formed magnetic body are denser.

Further, with respect to the smelting, pulverizing, orienting, forming, sintering and solution treatment, and aging treatment steps involved in the preparation method, certainly, these descriptions are merely exemplary, and the disclosed content of the present disclosure is not limited thereto.

The smelting step: placing raw materials such as PrNd (rare earth elements), BFe (ferroboron), pure Fe, and pure Cu, Al, Ga, Zr with doped elements in a smelting furnace for smelting, then performing casting to obtain an alloy cast strip or an alloy ingot; and weighing raw materials according to a formula (different alloy designations have different raw material ratios) of the alloy designation of the magnetic body, putting the raw materials in a vacuum smelting furnace, vacuumizing the furnace to be <1×10⁻¹ Pa, introducing an inert gas, raising the temperature to 1400-1700° C. for smelting, preserving the temperature for 5-30 min, and casting and spinning a high-temperature alloy solution after smelting to obtain the alloy cast strip, or pouring the high-temperature alloy solution into a water-cooling copper mold, and cooling the high-temperature alloy solution to obtain the alloy ingot.

The pulverizing step: coarsely crushing the alloy cast strip or the alloy ingot to obtain a coarse powder, and then finely crushing the coarse powder to obtain a fine powder, where coarse crushing may be listed as hydrogen crushing, and fine crushing may be listed as air-current mill crushing.

Hydrogen crushing: placing the alloy cast strip or the alloy ingot in a hydrogen crushing furnace, vacuumizing the hydrogen crushing furnace to be <1×10⁻¹ Pa at room temperature, and then introducing hydrogen with a purity of 99.9% into the hydrogen crushing furnace, where the alloy absorbs hydrogen fully at a hydrogen absorption temperature and a hydrogen absorption pressure; then raising the temperature to a dehydrogenation temperature while performing vacuumizing, where the alloy fully dehydrogenates; and then performing a cooling treatment to obtain a coarse powder, with a particle size range of 10-700 μm. The hydrogen absorption temperature may be listed as 20-300° C. The hydrogen absorption pressure may be listed as 50-600 kPa. The hydrogen absorption temperature may be listed as 400-700° C., further preferably 500-600° C.

Air-current mill crushing: placing the coarse powder in an air-current mill, and performing air-current mill pulverizing at a pressure of 0.1-2 MPa in an inert gas to obtain a fine powder with an average particle size of 2-5 um.

The sintering step: orienting a pressed green ware body for vacuum sintering. A vacuum degree is ≤1*10⁻¹ Pa, a sintering temperature is 1000-1100° C., and a sintering time is 2-8 h;

The aging treatment step: performing an aging treatment on a sintered magnetic body in a vacuum environment at 300-600° C. for 1-5 h, and performing a secondary aging treatment: performing a treatment at 600-1000° C. for 1-3 h first, and then performing cool to 400-600° C. for 1-5 h.

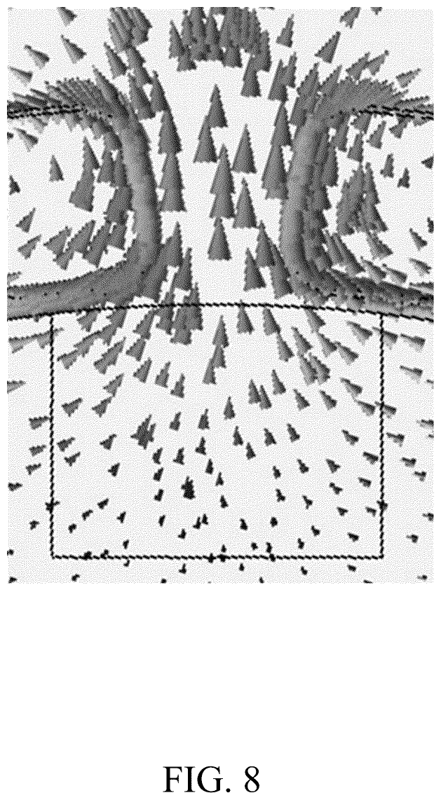

In this embodiment, the sintered magnetic body is magnetized after being ground, and a typical magnetic flux gathering surface is formed on a surface of a side of the magnetized product originally toward each of the oriented coils 330, as shown in FIG. 8.

The inert gas herein is one or more of nitrogen, helium, and argon.

The technical solutions of the present disclosure are further described below in conjunction with specific embodiments and drawings. It should be understood that the specific examples described herein are merely used for describing the present disclosure, rather than limiting the scope of the present disclosure. Furthermore, the drawings used herein are merely used for better illustrating contents disclosed by the present disclosure, rather than limiting the protection scope. Unless otherwise specified, raw materials used in the embodiments of the present disclosure are common raw materials in the art, and methods used in the embodiments are all conventional methods in the art.

### Example 1

A method for preparing a neodymium iron boron magnetic body with an arc-shaped orientation and an alloy designation of 42SH includes the following steps:
(1) smelting: formula components were weighed according to a molecular formula (Pr₂₀Nd₈₀)₃₀Dy₂B_{0.92}Zr_{0.1}Cu_{0.14}C₀₁Al_{0.55}Ga_{0.3}Fe_{residual} and placed in a vacuum smelting furnace, the vacuum smelting furnace was vacuumized to be <1×10⁻¹ Pa, an argon gas was introduced, and the temperature was raised to 1500° C. for smelting, the temperature was preserved for 20 min, and a high-temperature alloy solution was casted and spun after being smelted to obtain an alloy cast strip.
(2) pulverizing: the alloy cast strip was placed in a hydrogen crushing furnace, the hydrogen crushing furnace was vacuumized to be <1×10⁻¹ Pa at room temperature, and then hydrogen with a purity of 99.9% was introduced into the hydrogen crushing furnace, where the alloy absorbed hydrogen fully at 50° C. and 150 kPa; then the temperature was raised to 550° C. while vacuumizing was performed, where the alloy fully dehydrogenated; then a cooling treatment was performed to obtain a coarse powder; and the coarse powder was placed in an air-current mill, and air-current mill pulverizing was performed at a pressure of 0.5 MPa in an argon atmosphere to obtain a fine powder, with an average particle size of 2-5 μm.
(3) Orienting and forming: the fine powder was put in a mold, the mold was placed in a magnetic field with a magnetic field intensity of 2T under protection of an argon atmosphere for orientation, an oriented magnetic field was generated by an electric pulse and set with a plurality of oriented magnetic poles, and magnetic lines entered from the left and right surfaces and the lower surface of the magnetic body and went out from the upper surface, such that magnetic powder particles were oriented along a bent path from the left and right surface and the upper surface of the magnetic body to the upper surface in an orientation direction of an easy magnetization axis, to obtain a specific surface magnetic flux density distribution diagram. Then the oriented magnetic powder was pressed and formed, a pressed and formed green ware body was vacuum-encapsulated and placed in an isostatic pressure apparatus, and the pressure was maintained at 150 MPa for 10 s for isostatic pressing.
(4) sintering and aging: the isostatically pressed preform body was placed in a sintering furnace, in an argon atmosphere, the temperature was raised to 1080° C. for sintering for 8 h, after the temperature was decreased to room temperature, the temperature was raised again to 850° C. for treatment for 3 h, and then the temperature was decreased to 550° C. for treatment for 2 h, and finally, furnace cooling was performed till the temperature reached the room temperature.

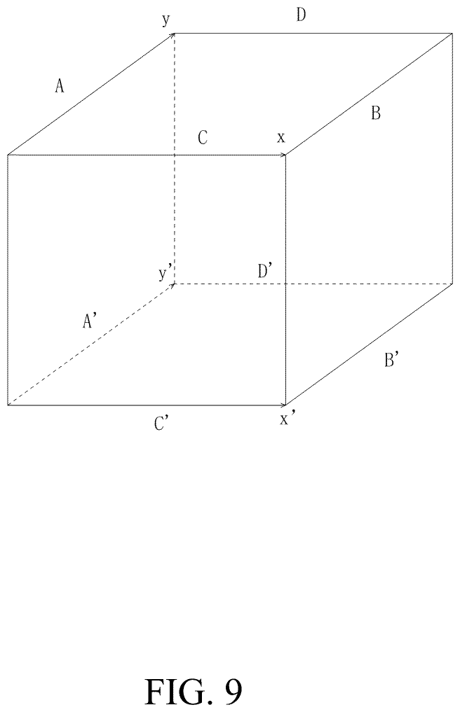

The prepared neodymium iron boron magnetic body is cuboid, a schematic diagram of which is shown in FIG. 9. The length of a side C is 15.7 mm, and the length of a side B is 12 mm and the thickness thereof is 10 mm. A magnetic pole on the upper surface of the neodymium iron boron magnetic body prepared in Example 1 is an S pole, and magnetic poles on the left and right surfaces and the lower surface are N poles.

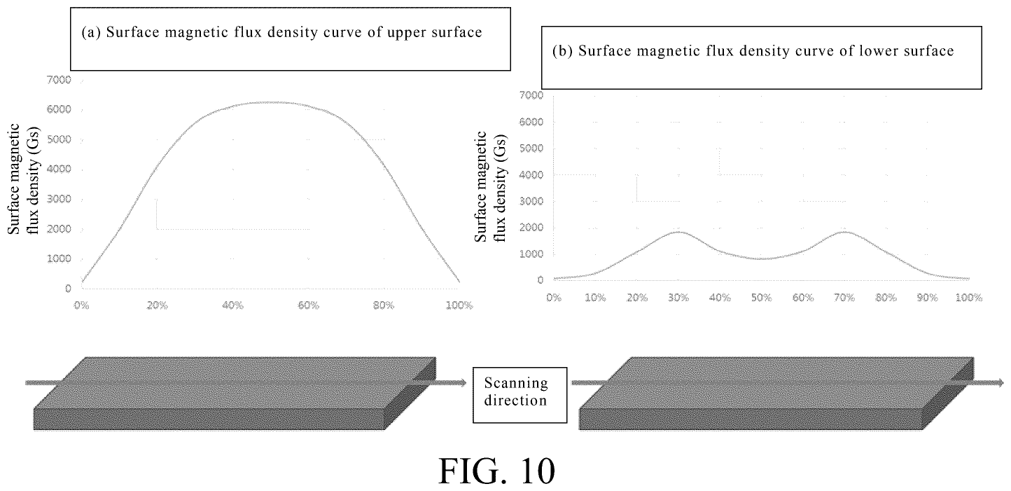

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value (abbreviated as “surface magnetism”). As shown in (a) in FIG. 10, the surface magnetic flux density of the upper surface of the magnetic body was in semicircle-like distribution, the maximum value of the surface magnetic flux density was located at a position where x was approximately equal to 50%, and the maximum value was 6246 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 10, the surface magnetic flux density of the lower surface of the magnetic body was in double wave peak distribution, i.e., had two wave peaks, a location point where the minimum surface magnetic flux density between two wave peaks was about x′=50%, which was located on a same vertical line with a location point (x=50%) where the maximum value of the surface magnetic flux density of the upper surface was located; the highest points of the two wave peaks were respectively located at positions where x′ was approximately equal to 30% and x′ was approximately equal to 70%, and the maximum surface magnetic flux density represented by the two wave peaks was 1838 Gs.

### Example 2

A method for preparing a neodymium iron boron magnetic body with an arc-shaped orientation and an alloy designation of 48H includes the following steps:
(1) smelting: formula components were weighed according to a molecular formula (Pr₂₀Nd₈₀)₃₁Dy_{0.6}B_{0.93}Zr_{0.15}Cu_{0.15}Co_{1.5}Al_{0.3}Ga_{0.3}Fe_{residual} and placed in a vacuum smelting furnace, the vacuum smelting furnace was vacuumized to be <1×10⁻¹ Pa, an argon gas was introduced, and the temperature was raised to 1500° C. for smelting, the temperature was preserved for 20 min, and a high-temperature alloy solution was casted and spun after being smelted to obtain an alloy cast strip.

Steps (2)-(4) are the same as those in Example 1. The difference lies in that the arrangement mode of the plurality of oriented magnetic poles in step (3) is adjusted, such that the specific surface magnetic flux density distribution diagram is obtained.

The prepared neodymium iron boron magnetic body is cuboid, a schematic diagram of which is shown in FIG. 9. The length of a side C is 15.7 mm, and the length of a side B is 12 mm and the thickness thereof is 10 mm. A magnetic pole on the upper surface of the neodymium iron boron magnetic body prepared in Example 2 is an S pole, and magnetic poles on the left and right surfaces and the lower surface are N poles.

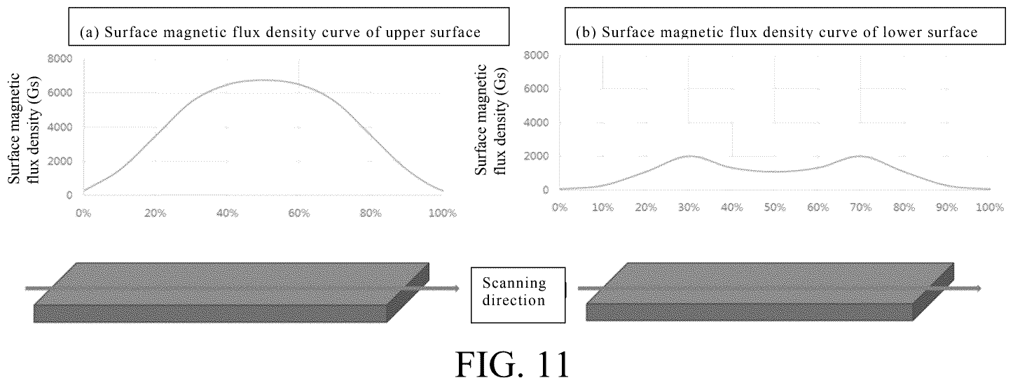

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value. As shown in (a) in FIG. 11, the surface magnetic flux density of the upper surface of the magnetic body was in normal-like distribution, the maximum value of the surface magnetic flux density was located at a position where x was approximately equal to 50%, and the maximum value was 6762 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 11, the surface magnetic flux density of the lower surface of the magnetic body was in double wave peak distribution, a location point where the minimum surface magnetic flux density between two wave peaks was about x′=50%, which was located on a same vertical line with a location point (x=50%) where the maximum value of the surface magnetic flux density of the upper surface was located; the highest points of the two wave peaks were respectively located at positions where x′ was approximately equal to 30% and x′ was approximately equal to 70%, and the maximum surface magnetic flux density represented by the two wave peaks was 1991 Gs.

### Example 3

A method for preparing a neodymium iron boron magnetic body with an arc-shaped orientation and an alloy designation of 35UH includes the following steps:

(1) smelting: formula components were weighed according to a molecular formula (Pr₂₀Nd₈₀)_{28.3}Dy₄B_{0.92}Zr_{0.15}Cu_{0.2}Co₂Al_{0.8}Ga_{0.2}Fe_{residual} and placed in a vacuum smelting furnace, the vacuum smelting furnace was vacuumized to be <1×10⁻¹ Pa, an argon gas was introduced, and the temperature was raised to 1500° C. for smelting, the temperature was preserved for 20 min, and a high-temperature alloy solution was casted and spun after being smelted to obtain an alloy cast strip.

Steps (2)-(4) are the same as those in Example 1. The difference lies in that the arrangement mode of the plurality of oriented magnetic poles in step (3) is adjusted, such that the specific surface magnetic flux density distribution diagram is obtained.

The prepared neodymium iron boron magnetic body is cuboid, a schematic diagram of which is shown in FIG. 9. The length of a side C is 15.7 mm, and the length of a side B is 12 mm and the thickness thereof is 10 mm. A magnetic pole on the upper surface of the neodymium iron boron magnetic body prepared in Example 3 is an S pole, and magnetic poles on the left and right surfaces and the lower surface are N poles.

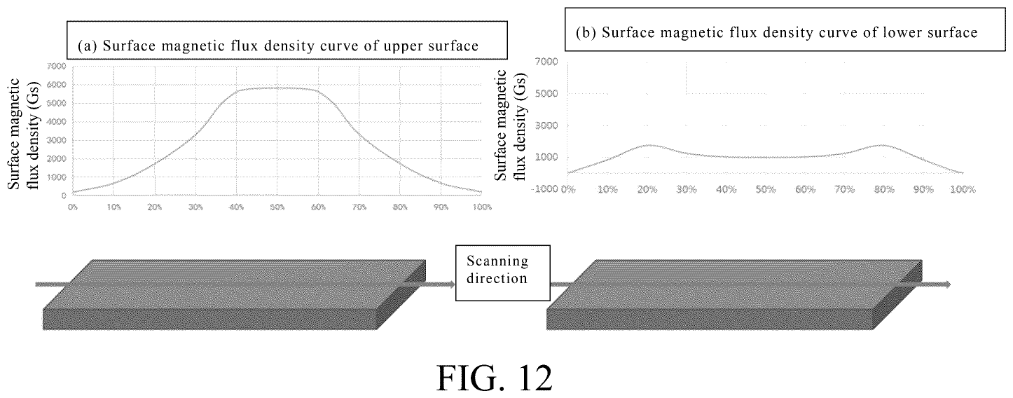

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value. As shown in (a) in FIG. 12, the surface magnetic flux density of the upper surface of the magnetic body was in trapezoid-like distribution, the maximum value of the surface magnetic flux density was located at an interval position where x=43-57%, and the maximum value was 5808 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 12, the surface magnetic flux density of the lower surface of the magnetic body was in double wave peak distribution, a location interval where the minimum surface magnetic flux density located between two wave peaks was about x′=40-60%, and a certain point (for example, x=50%) in the location interval of x=43-57% and a certain point (for example, x′=50%) of the location interval of x=40-60% were located on a same vertical line; the highest points of the two wave peaks were respectively located at positions where x′ was approximately equal to 20% and x′ was approximately equal to 80%, and the maximum surface magnetic flux density represented by the two wave peaks was 1743 Gs.

### Example 4

A method for preparing a neodymium iron boron magnetic body with an arc-shaped orientation and an alloy designation of 45H includes the following steps:
(1) smelting: formula components were weighed according to a molecular formula (Pr₂₀Nd₈₀)_{29.6}Dy_{0.3}Ho_{0.8}Gd_{0.7}B_{0.93}Zr_{0.15}Cu_{0.14}Co₁Al_{0.2}Ga_{0.2}Fe_{residual} and placed in a vacuum smelting furnace, the vacuum smelting furnace was vacuumized to be <1×10⁻¹ Pa, an argon gas was introduced, and the temperature was raised to 1500° C. for smelting, the temperature was preserved for 20 min, and a high-temperature alloy solution was casted and spun after being smelted to obtain an alloy cast strip.

Steps (2)-(4) are the same as those in Example 1. The difference lies in that the arrangement mode of the plurality of oriented magnetic poles in step (3) is adjusted, such that the specific surface magnetic flux density distribution diagram is obtained.

The prepared neodymium iron boron magnetic body is cuboid, a schematic diagram of which is shown in FIG. 9. The length of a side C is 15.7 mm, and the length of a side B is 12 mm and the thickness thereof is 10 mm. A magnetic pole on the upper surface of the neodymium iron boron magnetic body prepared in Example 4 is an S pole, and magnetic poles on the left and right surfaces and the lower surface are N poles.

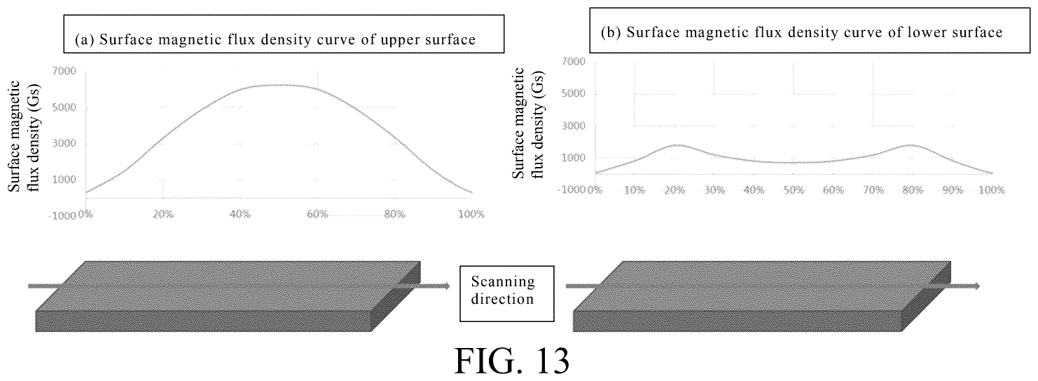

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value. As shown in (a) in FIG. 13, the surface magnetic flux density of the upper surface of the magnetic body was in normal-like distribution, the maximum value of the surface magnetic flux density was located at a position where x was approximately equal to 50%, and the maximum value was 6248 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 13, the surface magnetic flux density of the lower surface of the magnetic body was in double wave peak distribution, a location point where the minimum surface magnetic flux density between two wave peaks was about x′=50%, which is located on a same vertical line with a location point (x=50%) where the maximum value of the surface magnetic flux density of the upper surface was located; the highest points of the two wave peaks were respectively located at positions where x′ was approximately equal to 20% and x′ was approximately equal to 80%, and the maximum surface magnetic flux density represented by the two wave peaks was 1785 Gs.

### Example 5

A method for preparing a neodymium iron boron magnetic body with an arc-shaped orientation and an alloy designation of 50M includes the following steps:

(1) smelting: formula components were weighed according to a molecular formula (Pr₂₀Nd₈₀)₃₁Dy_{0.92}B_{0.92}Zr_{0.15}Cu_{0.2}Co_{0.9}Al_{0.2}Ga_{0.2}Fe_{residual} and placed in a vacuum smelting furnace, the vacuum smelting furnace was vacuumized to be <1×10⁻¹ Pa, an argon gas was introduced, and the temperature was raised to 1500° C. for smelting, the temperature was preserved for 20 min, and a high-temperature alloy solution was casted and spun after being smelted to obtain an alloy cast strip.

Steps (2)-(4) are the same as those in Example 1. The difference lies in that the arrangement mode of the plurality of oriented magnetic poles in step (3) is adjusted, such that the specific surface magnetic flux density distribution diagram is obtained.

The prepared neodymium iron boron magnetic body is cuboid, a schematic diagram of which is shown in FIG. 9. The length of a side Cis 15.7 mm, and the length of a side B is 12 mm and the thickness thereof is 10 mm. A magnetic pole on the upper surface of the neodymium iron boron magnetic body prepared in Example 5 is an S pole, and magnetic poles on the left and right surfaces and the lower surface are N poles.

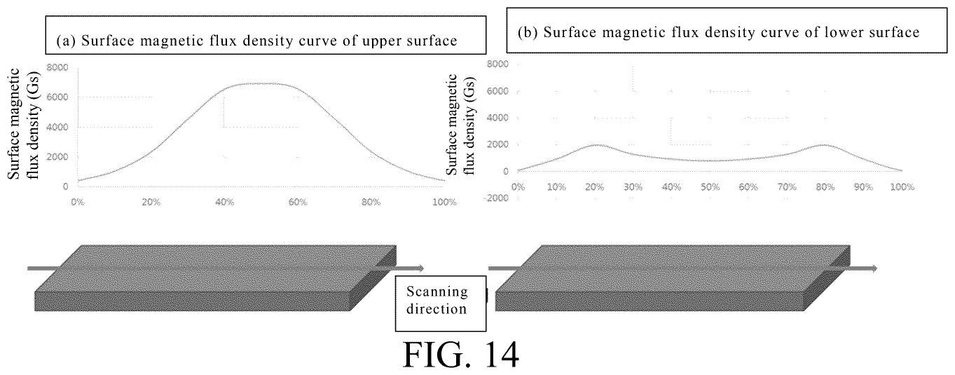

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value. As shown in (a) in FIG. 14, the surface magnetic flux density of the upper surface of the magnetic body was in trapezoid-like distribution, the maximum value of the surface magnetic flux density was located at an interval position where x=45-55%, and the maximum value was 6923 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 14, the surface magnetic flux density of the lower surface of the magnetic body was in double wave peak distribution, a location point where the minimum surface magnetic flux density between two wave peaks was about x′=50%, which is located on a same vertical line with x=50% in the interval location of x=45-55% where the maximum value of the surface magnetic flux density of the upper surface was located; the highest points of the two wave peaks were respectively located at positions where x′ was approximately equal to 20% and x′ was approximately equal to 80%, and the maximum surface magnetic flux density represented by the two wave peaks was 1950 Gs.

### Example 6

A method for preparing a samarium cobalt magnetic body with an arc-shaped orientation includes the following steps:
(1) smelting: formula components were weighed according to a molecular formula Sm(Co_{residual}Fe_{0.25}Cu_{0.048}Zr_{0.028})_{7.3} and placed in a vacuum smelting furnace, the vacuum smelting furnace was vacuumized to be <1×10⁻² Pa, an argon gas was introduced, and the temperature was raised to 1450° C. for smelting, the temperature was preserved for 10 min, and a high-temperature alloy solution was casted and spun after being smelted to obtain an alloy cast strip.
(2) pulverizing: the alloy cast strip was placed in a hydrogen crushing furnace, the hydrogen crushing furnace was vacuumized to be <1×10⁻¹ Pa at room temperature, and then hydrogen with a purity of 99.9% was introduced into the hydrogen crushing furnace, where the alloy absorbed hydrogen fully at 60° C. and 200 kPa; then the temperature was raised to 500° C. while vacuumizing was performed, where the alloy fully dehydrogenated; then a cooling treatment was performed to obtain a coarse powder; and the coarse powder was placed in an air-current mill, and air-current mill pulverizing was performed at a pressure of 0.5 MPa in an argon atmosphere to obtain a fine powder, with an average particle size of 2-5 μm.
(3) Orienting and forming: the fine powder was put in a mold, the mold was placed in a magnetic field with a magnetic field intensity of 2T under protection of an argon atmosphere for orientation, an oriented magnetic field was generated by an electric pulse and set with a plurality of oriented magnetic poles, and magnetic lines entered from the left and right surfaces and the lower surface of the magnetic body and went out from the upper surface, such that magnetic powder particles were oriented along a bent path from the left and right surface and the upper surface of the magnetic body to the upper surface in an orientation direction of an easy magnetization axis, to obtain a specific surface magnetic flux density distribution diagram. Then the oriented magnetic powder was pressed and formed, a pressed and formed green ware body was vacuum-encapsulated and placed in an isostatic pressure apparatus, and the pressure was maintained at 180 MPa for 20 s for isostatic pressing.
(4) sintering and aging: the isostatically pressed preform body was placed in a sintering furnace, in an argon atmosphere, the temperature was raised to 1200° C. for sintering for 2 h, then the temperature was decreased to 1180° C. for a solution heat treatment for 4 h, after the solution heat treatment, cooling was performed, the temperature was raised again to 830° C. for treatment for 18 h, and then the temperature was decreased to 420° C. for treatment for 2 h at 0.6° C./min, and finally, furnace cooling was performed till the temperature reached the room temperature.

The prepared samarium cobalt magnetic body is cuboid, a schematic diagram of which is shown in FIG. 9. The length of a side C is 15.7 mm, and the length of a side B is 12 mm and the thickness thereof is 10 mm. A magnetic pole on the upper surface of the samarium cobalt magnetic body prepared in Example 6 is an S pole, and magnetic poles on the left and right surfaces and the lower surface are N poles.

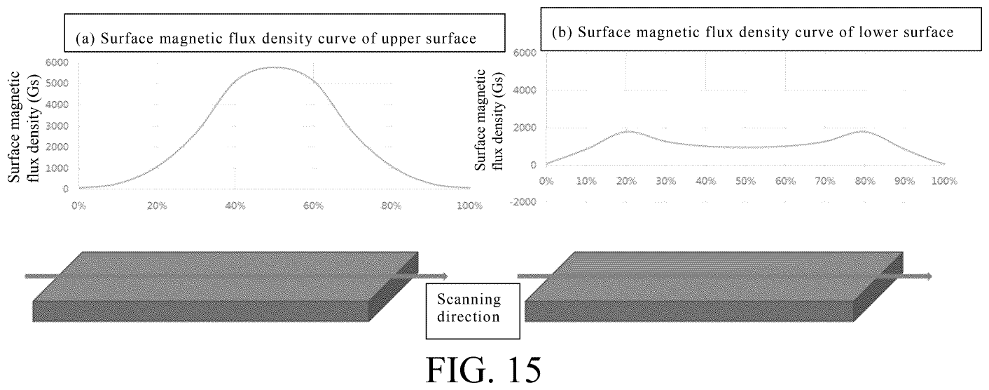

The surface magnetic flux density of the upper surface was tested along an intersecting line of the upper surface, and a curve was drawn to obtain a surface magnetic flux density distribution diagram with the abscissa being a location point (0-100%) of x axis and the ordinate being a surface magnetic flux density value. As shown in (a) in FIG. 15, the surface magnetic flux density of the upper surface of the magnetic body was in normal-like distribution, the maximum value of the surface magnetic flux density was located at a position where x was approximately equal to 50%, and the maximum value was 5767 Gs.

The surface magnetic flux density of the lower surface was tested along an intersecting line of the lower surface, and a curve was drawn to obtain a surface magnetic flux density distribution diagram with the abscissa being a location point (0-100%) of x′ axis and the ordinate being a surface magnetic flux density value. As shown in (b) in FIG. 15, the surface magnetic flux density of the lower surface of the magnetic body was in double wave peak distribution, i.e., had two wave peaks, a location point where the minimum surface magnetic flux density between two wave peaks was about x′=50%, which was located on a same vertical line with a location point (x=50%) where the maximum value of the surface magnetic flux density of the upper surface was located; the highest points of the two wave peaks were respectively located at positions where x′ was approximately equal to 20% and x′ was approximately equal to 80%, and the maximum surface magnetic flux density represented by the two wave peaks was 1772 Gs.

### Comparative Example 1

The different between Comparative Example 1 and Example 1 lies in that during orientation in (3) of the Comparative Example 1, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 1.

### Comparative Example 2

The different between Comparative Example 2 and Example 2 lies in that during orientation in (3) of the Comparative Example 2, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 2.

### Comparative Example 3

The different between Comparative Example 3 and Example 3 lies in that during orientation in (3) of the Comparative Example 1, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 3.

### Comparative Example 4

The different between Comparative Example 4 and Example 4 lies in that during orientation in (3) of the Comparative Example 4, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 4.

### Comparative Example 5

The different between Comparative Example 5 and Example 5 lies in that during orientation in (3) of the Comparative Example 5, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 5.

### Comparative Example 6

The different between Comparative Example 6 and Example 6 lies in that during orientation in (3) of the Comparative Example 6, parallel orientation is used, i.e., the magnetic lines enter from the lower surface of the magnetic body and go out from the upper surface, such that magnetic powder particles are oriented along a parallel path from the lower surface of the magnetic body to the upper surface in an orientation direction of an easy magnetization axis. Other steps are the same as those in Example 6.

TABLE 1
Maximum surface magnetic flux densities of the upper and lower surfaces of
the magnetic bodies prepared in Examples 1-6 and Comparative Examples 1-6

| | | | | Increased | Increased | Ratio of the |
|---|---|---|---|---|---|---|
| | | | | proportions of the | proportions of the | maximum |
| | | | | maximum surface | maximum surface | surface |
| | | | | magnetic flux | magnetic flux | magnetic flux |
| | | | | density of the | density of the | density of the |
| | | | | upper surface in | lower surface in | upper surface in |
| | | | | the present | the present | the present |
| | | | | disclosure and the | disclosure and the | disclosure to the |
| | | Maximum surface | | maximum surface | maximum surface | maximum |
| | | magnetic flux density | | magnetic flux | magnetic flux | surface |
| | | Upper | Lower | density of the | density of the | magnetic flux |
| | Remanence | surface | surface | parallelly oriented | parallelly oriented | density of the |
| Examples | Br(kGs) | (Gs) | (Gs) | upper surface | lower surface | lower surface |
| Example 1 | 13.2 | 1838 | 6246 | 22.04% | 64.17% | 3.40 |
| Comparative | | 5130 | 5118 | | | / |
| Example 1 | | | | | | |
| Example 2 | 13.9 | 1991 | 6762 | 24.99% | 62.66% | 3.40 |
| Comparative | | 5332 | 5410 | | | / |
| Example 2 | | | | | | |
| Example 3 | 12.1 | 1743 | 5808 | 23.18% | 63.00% | 3.33 |
| Comparative | | 4711 | 4715 | | | / |
| Example 3 | | | | | | |
| Example 4 | 13.5 | 1785 | 6248 | 22.29% | 65.14% | 3.50 |
| Comparative | | 5121 | 5109 | | | / |
| Example 4 | | | | | | |
| Example 5 | 14.1 | 1950 | 6923 | 31.99% | 62.76% | 3.55 |
| Comparative | | 5236 | 5245 | | | / |
| Example 5 | | | | | | |
| Example 6 | 11.8 | 1772 | 5767 | 26.22% | 61.25% | 3.25 |
| Comparative | | 4573 | 4569 | | | / |
| Example 6 | | | | | | |

In the Table: the increased proportions of the maximum surface magnetic flux density of the upper surface of the magnetic body in the present disclosure and the maximum surface magnetic flux density of the parallelly oriented upper surface of the magnetic body=(the maximum surface magnetic flux density of the upper surface of the magnetic body in the present disclosure−the maximum surface magnetic flux density of the parallelly oriented upper surface of the magnetic body)/the maximum surface magnetic flux density of the parallelly oriented upper surface of the magnetic body*100%.

The decreased proportions of the maximum surface magnetic flux density of the lower surface of the magnetic body in the present disclosure and the maximum surface magnetic flux density of the parallelly oriented upper surface=(the maximum surface magnetic flux density of the upper surface of the magnetic body in the present disclosure−the maximum surface magnetic flux density of the parallelly oriented upper surface of the magnetic body)/the maximum surface magnetic flux density of the parallelly oriented upper surface of the magnetic body*100%.

The ratio of the maximum surface magnetic flux density of the upper surface of the magnetic body in the present disclosure to the maximum surface magnetic flux density of the lower surface of the magnetic body=the maximum surface magnetic flux density of the upper surface/the maximum surface magnetic flux density of the lower surface.

It may be seen from the Table that compared with the maximum value of the surface magnetic flux density of the parallelly oriented upper surface of the magnetic body used in Comparative Examples 1-6, the maximum value of the surface magnetic flux density of the upper surface of the magnetic bodies in Examples 1-6 is increased by ≥22.04%. Compared with the maximum value of the surface magnetic flux density of the parallelly oriented lower surface of the magnetic body used in Comparative Examples 1-6, the maximum value of the surface magnetic flux density of the lower surface of the magnetic bodies in Examples 1-6 is reduced by ≥61.25%. The ratio of the maximum value of the surface magnetic flux density of the upper surface of the magnetic bodies in Examples 1-6 to the maximum value of the surface magnetic flux density of the lower surface is ≥3.25.

The magnetic body obtained by oriented forming of the magnetic powder has a very high surface magnetic flux density, and the highest surface magnetic flux density value is concentrated in a certain region of the upper surface, which meets the requirement on a relatively high magnetic flux density of a special surface in a special field.

It should be noted that the descriptions of “first”, “second”, “one”, and the like in the present disclosure are used for the purpose of description only, but cannot be understood as indicating or implying the relative importance thereof or implicitly indicating the number of the indicated technical features. Thus, features defining “first” and “second” may expressively or implicitly include at least one feature. In the description of the present disclosure, unless otherwise specified, “a plurality of” means at least two, for example, two, three, and the like. The terms “connect”, “fix”, and the like shall be understood in a broad sense, for example, “fix” may be fixed connection or detachable connection or integrated connection; it may be mechanical connection or electrical connection; it may be direct connection or indirect connection via an intermediate, or it may be internal connection or interaction of two components, unless otherwise specified. Those of ordinary skill in the art may understand the specific meaning of the terms in the present disclosure under specific circumstances.

In addition, the technical solutions of the embodiments of the present disclosure may be combined with one another based on implementation by those of ordinary skill in the art. When the technical solutions contradict each other in combination or may not be realized, it is to be considered that there is no combination of the technical solutions, which shall not fall into the protection scope of the present disclosure.

The specific embodiments described herein are merely illustrations of the spirit of the present disclosure. Those skilled in the art may make various modifications or supplementations on the specific embodiments described or replace the modifications or supplementations in a similar manner, without departing from the spirit of the present disclosure or surpassing the scope defined by the appended claims.

What is claimed is:

1. A mold for preparing a magnetic body having a surface magnetic flux gathering function, comprising:
a mold cavity, comprising a cavity opening of the mold cavity and a cavity bottom of the mold cavity, the cavity opening of the mold cavity and the cavity bottom of the mold cavity being oppositely provided up and down;
a first alloy block and a second alloy block, the first alloy block and the second alloy block being both movable up and down along an opening direction of the cavity opening of the mold cavity, wherein the first alloy block moves to close or open the cavity opening of the mold cavity, and the second alloy block is located at the cavity bottom of the mold cavity and moves to demold a formed magnetic body in the mold cavity; and
two oriented coils, provided in the first alloy block or the second alloy block and located in a same horizontal plane, wherein in a case where currents in opposite directions are fed into the two oriented coils, the two oriented coils respectively form a first magnetic field and a second magnetic field with magnetic lines distributed in concentric circles, and the magnetic lines generated by the first magnetic field and the second magnetic field repulse each other and do not intersect with each other in a region between the two oriented coils, such that a spacing between any two adjacent magnetic lines on a side of upper and lower sides of the formed magnetic body close to the oriented coils is less than a spacing between corresponding two adjacent magnetic lines on a side away from the oriented coils.

2. The mold for preparing a magnetic body having a surface magnetic flux gathering function according to claim 1, wherein in a case where the two oriented coils are provided in the first alloy block and the currents in opposite directions are fed into the oriented coils, a density of the magnetic lines on a side toward the cavity opening of the mold cavity is greater than a density of the magnetic lines on a side toward the cavity bottom of the mold cavity, such that a surface magnetic force on a side close to the cavity opening of the mold cavity is larger than a surface magnetic force on a side away from the cavity bottom of the mold cavity on the formed magnetic body in the mold cavity.

3. The mold for preparing a magnetic body having a surface magnetic flux gathering function according to claim 2, wherein the magnetic lines of the magnetic fields formed by the two oriented coils enter the formed magnetic body from the side away from the oriented coils, and leave the formed magnetic body from the side close to the oriented coils and return to corresponding oriented coils.

4. The mold for preparing a magnetic body having a surface magnetic flux gathering function according to claim 3, wherein the magnetic lines in the magnetic fields generated by the oriented coils enter from one or more sides of the formed magnetic body in an arc-shaped curve manner, and leave from a side of the formed magnetic body and return to the corresponding oriented coils, and wherein an included angle between a tangent line entering a side of the formed magnetic body on an arc-shaped curve and a vertical plane is greater than an included angle between a tangent line leaving a side of the formed magnetic body on the corresponding arc-shaped curve and the vertical plane.

5. The mold for preparing a magnetic body having a surface magnetic flux gathering function according to claim 2, wherein in a case where the two oriented coils are symmetrically distributed along the mold cavity, a strongest surface magnetic force region on the side toward the oriented coils on the formed magnetic body is located in a middle region of the formed magnetic body; and in a case where the two oriented coils are asymmetrically distributed along the mold cavity, the strongest surface magnetic force region on the side toward the oriented coils on the formed magnetic body is close to a side away from the cavity mold in the two oriented coils.

6. The mold for preparing a magnetic body having a surface magnetic flux gathering function according to claim 5, wherein in a case where the two oriented coils are symmetrically distributed along the mold cavity and are located in the first alloy block, outermost magnetic lines of the first magnetic field and the second magnetic field formed by the two oriented coils are tangential to form a point of tangency, and wherein the point of tangency is located outside the formed magnetic body, and a vertical symmetric axis of the formed magnetic body passes through the point of tangency.

7. The mold for preparing a magnetic body having a surface magnetic flux gathering function according to claim 4, wherein the mold cavity further comprises a plurality of cavity walls of the mold cavity, located in a lateral part of the mold cavity, and wherein in a case where the two oriented coils are located in the first alloy block along the mold cavity, the magnetic lines of the magnetic fields formed by the two oriented coils enter the formed magnetic body from respective opposite sides of the cavity bottom of the mold cavity and the cavity walls of the mold cavity, and leave the formed magnetic body from an opposite side of the cavity opening of the mold cavity and return to the corresponding oriented coils.

8. The mold for preparing a magnetic body having a surface magnetic flux gathering function according to claim 7, wherein a pressing direction of a permanent magnet material in the mold cavity is perpendicular to a demolding direction formed after the permanent magnetic material is pressed and formed.

9. The mold for preparing a magnetic body having a surface magnetic flux gathering function according to claim 8, wherein four cavity walls of the mold cavity are provided on the mold cavity, two oppositely provided cavity walls of the mold cavity in the four cavity walls of the mold cavity are movably provided and are movable cavity walls of the mold cavity, and the other two oppositely provided cavity walls of the mold cavity are fixedly provided and are fixed cavity walls of the mold cavity, and wherein a side where the movable cavity walls of the mold cavity are located is the pressing direction of the permanent magnetic material, and a side where the cavity opening of the mold cavity is located is the demolding direction of the magnetic body after the permanent magnetic material is formed.

10. The mold for preparing a magnetic body having a surface magnetic flux gathering function according to claim 9, wherein the pressing direction of the permanent magnetic material in the mold cavity is parallel to an axial direction of each of the oriented coils, and a vertical plane where each of the oriented coils is located is parallel to a vertical plane where the fixed wall cavities of the mold cavity on the corresponding side.

11. The mold for preparing a magnetic body having a surface magnetic flux gathering function according to claim 1, wherein the mold further comprises a forming template and the mold cavity is located in the forming template, and wherein an included angle α is formed between a connecting line between the lowest point of each of the oriented coils and the highest point of the corresponding side wall on the forming template and a vertical plane where the corresponding side wall is located, and a degree of the included angle α is between 0° and 90°.

12. The mold for preparing a magnetic body having a surface magnetic flux gathering function according to claim 11, wherein the degree of the included angle α is between 30° and 70°.

13. The mold for preparing a magnetic body having a surface magnetic flux gathering function according to claim 9, further comprising:
an operation panel, respectively provided with an upper surface and a lower surface along the demolding direction of the formed magnetic body, the forming template being mounted on the upper surface of the operation panel;
a movable mold mechanism, mounted on the forming template or the upper surface of the operation panel through a first support, an output end of the movable mold mechanism being connected to the first alloy block, wherein the two oriented coils are provided in parallel in the first alloy block;
a demolding mechanism, mounted on the lower surface of the operation panel through a second support, an output end of the demolding mechanism being connected to the second alloy block, wherein in a case where the permanent magnetic material is pressed, a surface on a side toward the mold cavity on the second alloy block is flush with the cavity bottom of the mold cavity; and in a case where the magnetic body is formed, the second alloy block stretches into the mold cavity to demold the formed magnetic body; and
a first pressing mechanism, mounted on the operation panel through a third support, and a second pressing mechanism, mounted on the operation panel through a fourth support, the first pressing mechanism and the second pressing mechanism being respectively located on two sides of the forming template, wherein an output end of the first pressing mechanism is provided with a first movable part, an output end of the second pressing mechanism is provided with a second movable part, and the first movable part and the second movable part are respectively two oppositely provided movable cavity walls of the mold cavity on the mold cavity.

14. The mold for preparing a magnetic body having a surface magnetic flux gathering function according to claim 13, wherein the first support comprises a first support plate parallel to a plane where the cavity opening of the mold cavity is located and each corner of the first support plate is provided with a support column, and wherein one end of the support column is connected to the first support plate and the other end of the support column is connected to forming template or the upper surface of the operation panel, and a power source of the movable mold mechanism is mounted on the first support plate; or the second support is provided in a C shape, and two sides of an opening end of the second support are respectively connected to the lower surface of the operation panel, wherein a power source of the demolding mechanism is connected to a closed end of the second support; or two slotted holes are provided in the operation panel along the demolding direction of the formed magnetic body, the slotted holes penetrate through the upper surface and the lower surface of the operation panel, and a third support and a fourth support are respectively located in the two slotted holes, wherein a power source of the first pressing mechanism and a power source of the second pressing mechanism are embedded into the corresponding slotted holes.

15. A magnetic body, formed by using the mold according to claim 9, wherein the magnetic body is one of a neodymium iron boron permanent magnet, a samarium cobalt permanent magnet, an aluminum nickel cobalt permanent magnet, and a ferrimagnet.

16. The magnetic body according to claim 15, wherein a method for preparing a magnetic body sequentially comprises: smelting, pulverizing, orienting, forming, sintering, and aging; in the orienting process, a fine powder obtained by pulverizing is placed in a mold, then a pulsed power supply is started to open a pulsed magnet field for orientation, magnetic lines of two electric fields enter the magnetic body in an arc shape from a side opposite to the cavity bottom of the mold cavity and a side opposite to the fixed cavity walls of the mold cavity, and leave from a side opposite to the cavity opening of the mold cavity and return to the corresponding oriented coils, wherein surface magnetic lines on the side same with the cavity opening of the mold cavity on the formed magnetic body are denser.

17. The magnetic body according to claim 15, wherein compared with a maximum value of a surface magnetic flux density of an upper surface of a magnetic body oriented in parallel with the same size, the same alloy designation, and the same Br, a maximum value of a surface magnetic flux density of an upper surface of the magnetic body is increased by ≥15%, or compared with a maximum value of a surface magnetic flux density of a lower surface of a magnetic body oriented in parallel with the same specification, the same alloy designation, and the same Br, a maximum value of a surface magnetic flux density of a lower surface of the magnetic body is decreased by ≥30%.

18. The magnetic body according to claim 15, wherein along an intersecting line of the lower surface, the surface magnetic flux density of the lower surface of the magnetic body is in double wave peak distribution, and the intersecting line of the lower surface is coplanar with an intersecting line of the upper surface and a formed surface is parallel to a front surface.

19. The magnetic body according to claim 15, wherein a location point where a minimum surface magnetic flux density is located between double wave peaks and a location point where the maximum value of the surface magnetic flux density of the upper surface are located on a same vertical line.

20. An application of the magnetic body according to claim 15 in an electronic information device.
